(19) United States
(12) Patent Application Publication
(10) Pub. No.: US 2010/0063869 A1
(43) Pub. Date: Mar. 11, 2010

(54) METHODS AND APPARATUS TO CREATE MODELING GROUPS FOR USE IN TRADE PROMOTION RESPONSE MODELS

(76) Inventor: Mitchel Kriss, Long Grove, IL (US)

Correspondence Address: Hanley, Flight & Zimmerman, LLC, 150 S. Wacker Dr. Suite 2100, Chicago, IL, 60606, US

(21) Appl. No.: 12/414,822

(22) Filed: Mar. 31, 2009

Related U.S. Application Data
(60) Provisional application No. 61/094,777, filed on Sep. 5, 2008.

(51) Int. Cl. G06Q 10/00; G06Q 30/00

(52) U.S. Cl. 705/10; 705/14.49

(57) ABSTRACT

Methods and apparatus to create modeling groups for use in trade promotion response models are disclosed. An example computer implemented method to generate a modeling group for use in a trade promotion response model includes generating products groups, each of which includes one or more product codes corresponding to substantially similar products; generating advertisement identifiers, each of which corresponds to an advertisement and one or more product codes associated with one or more products in the advertisement; selecting a first product group from the product groups; selecting one of the advertisement identifiers corresponding to one or more product codes that are also in the first product group; and generating a modeling group for a trade promotion response model by grouping together ones of the product groups that include the product codes corresponding to the selected one of the advertisement identifiers.

### RELATED APPLICATION

This patent claims the benefit of U.S. Provisional Patent Application No. 61/094,777, filed on Sep. 5, 2008, which is hereby incorporated by reference herein in its entirety.

### FIELD OF THE DISCLOSURE

The present patent relates generally to consumer goods and, more particularly, to methods and apparatus to create modeling groups for use in trade promotion response models.

### BACKGROUND

Retail establishments and product manufacturers are often interested in the shopping activities, behaviors, and/or habits of consumers. Consumer activity related to shopping can be used to correlate product sales with particular shopping behaviors and/or to improve timing or placement of product offerings, product promotions, and/or advertisements. To obtain and make use of such information, market analysis entities typically utilize a plurality of statistical tools to study, evaluate, and/or predict market conditions and/or consumer behavior. One such statistical tool is a promotion response model, which provides information related to the effects of one or more promotions (e.g., sales, discounts, free gifts with purchases, contests, coupons, etc.) on, for example, a specific segment of consumers (e.g., a geographically and/or demographically categorized group of people). Generally, a promotion response model uses data (e.g., product types, prices, promotion characteristics, geographic locations, in-store locations, durations, sales data, etc.) associated with a promotion of one or more products to generate an output indicative of the impact of the promotion on, for example, revenues associated with the promoted product.

One such output is a response index, which a promotion response model can calculate based on consumer activity patterns (e.g., purchasing statistics) occurring at, for example, a retail establishment (e.g., a grocery store) at which a promotion is being run. The response index conveys an indication (e.g., a likelihood of different types of responses, an expected change in revenue, a range of return on the promotional investment) of how consumers of a targeted demographic are likely to behave in response to a potential promotion. Thus, businesses (e.g., media planners, marketing strategists, etc.) can use the response index or any other indicator generated by a promotion response model to estimate the effects of different types of promotions on different types of consumers and can adjust strategies and/or budgets accordingly.

### BRIEF DESCRIPTION OF THE DRAWINGS

FIG. 1 is a block diagram of an example promotion response modeling system.

FIG. 2 is a block diagram of an example apparatus that may be used to implement the example modeling group generator of FIG. 1.

FIG. 3 is an illustration of the processing of product and advertisement data performed by the example modeling group generator of FIG. 2.

FIG. 4 is a table depicting an example initial modeling group received by the token test unit and the results of the example token test.

FIG. 5 is a flow diagram representative of an example method that may be performed to implement the example modeling system of FIG. 1 to create modeling groups for use in trade promotion response models.

FIG. 6 is a flow diagram representative of an example method that may be performed to implement the example modeling group generator of FIG. 2.

FIG. 7 is a block diagram of an example processor system that may be used to implement some or all of the example methods and apparatus described herein.

### DETAILED DESCRIPTION

Although the following discloses example methods, apparatus, systems, and articles of manufacture including, among other components, firmware and/or software executed on hardware, it should be noted that such methods, apparatus, systems, and articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

An example computer implemented method to generate a modeling group for use in a trade promotion response model includes generating products groups, each of which includes one or more product codes corresponding to substantially similar products. Further, the example computer implemented method includes generating advertisement identifiers, each of which corresponds to an advertisement and one or more product codes associated with one or more products in the advertisement. Further, the example computer implemented method includes selecting a first product group from the product groups. Further, the example computer implemented method includes selecting one of the advertisement identifiers corresponding to one or more product codes that are also in the first product group. Further, the example computer implemented method includes generating a modeling group for a trade promotion response model by grouping together ones of the product groups that include the product codes corresponding to the selected one of the advertisement identifiers.

An example computer readable medium has instructions stored thereon that, when executed, cause a machine to generate products groups, each of which includes one or more product codes corresponding to substantially similar products. Further, the example computer readable medium has instructions stored thereon that, when executed, cause a machine to generate advertisement identifiers, each of which corresponds to an advertisement and one or more product codes associated with one or more products in the advertisement. Further, the example computer readable medium has instructions stored thereon that, when executed, cause a machine to select a first product group from the product groups. Further, the example computer readable medium has instructions stored thereon that, when executed, cause a machine to select one of the advertisement identifiers corresponding to one or more product codes that are also in the first product group. Further, the example computer readable medium has instructions stored thereon that, when executed, cause a machine to generate a modeling group for a trade promotion response model by grouping together ones of the product groups that include the product codes corresponding to the selected one of the advertisement identifiers.

An example modeling group generator for use in a trade promotion response model includes a unit definer to generate products groups, each of which includes one or more product codes corresponding to substantially similar products. Further, the example modeling group generator includes a feature identifier generator to generate advertisement identifiers, each of which corresponds to an advertisement and one or more product codes associated with one or more products in the advertisement. Further, the example modeling group generator includes a unit selector to select a first product group from the product groups. Further, the example modeling group generator includes a feature selector to select one of the advertisement identifiers corresponding to one or more product codes that are also in the first product group. Further, the example modeling group generator includes a unit grouper to generate a modeling group for a trade promotion response model by grouping together ones of the product groups that include the product codes corresponding to the selected one of the advertisement identifiers.

An example trade promotion response modeling system includes a promotion detection system to collect information related to a plurality of advertisements. Further, the example trade promotion response modeling system includes a product characteristic source including product characteristics associated with a plurality of products of a marketplace. Further, the example trade promotion response modeling system includes a sales trend data source including financial information related to the plurality of products. Further, the example trade promotion response modeling system includes a modeling group generator including a plurality of product groups, each of which includes one or more product codes corresponding to substantially similar products. Further, the example modeling group generator a plurality of advertisement identifiers, each of which corresponds to an advertisement and one or more product codes associated with one or more products in the advertisement, wherein the modeling group generator is configured to select a first one of the advertisements based on a first code of a first one of the product groups, and wherein the modeling group generator is configured to generate a modeling group for a trade promotion response model by grouping together ones of the product groups that include the product codes corresponding to the selected one of the advertisement identifiers.

The example methods, apparatus, systems, and articles of manufacture described herein may be implemented by a consumer metering entity, by retail businesses, by marketing professionals, and/or by any other entity interested in understanding consumers of goods and/or services and/or how to reach and influence those consumers. Such entities often develop and utilize trade promotion response models to optimize and/or predict the effect that running a trade promotion on a particular product (e.g., a good or service) during a particular period of time has on the sales performance of that product.

Generating promotion response models typically involves grouping products that share one or more characteristics into modeling groups. Currently, the creation of modeling groups is typically performed manually and, given the vast amount of available products, often consumes large amounts of costly labor. For example, teams of expensive analysts are often used to compile large amounts of data to define the modeling groups and to populate these modeling groups. In fact, the generation of thorough (e.g., highly granular) modeling groups using such conventional methods and/or systems is often economically impractical and, thus, typically not performed. Instead, modeling groups usually include estimations and extrapolations based on a set of data representing only a small segment of an actual marketplace. This approach limits the scope of products covered in the modeling groups and, thus, limits the reach of the modeling analysis of the available products on the marketplace and impact of promotions on these available products.

Further, conventional manual creation of modeling groups involves subjective decisions made by a plurality of individuals and/or groups (e.g., product marketing experts), each of whom may be operating under a different set of rules and/or opinions of what product belongs in what modeling group. In other words, different modeling group definitions are created and/or followed by different members contributing to the same response modeling system. Such an approach, which inherently introduces analyst bias and/or error, generates inconsistent results, thereby reducing the reliability of the end result (e.g., the information generated to provide analysis and/or predictive value).

Further, the manner in which manufacturers promote products (which is one of the factors analyzed by some of the promotion response models described above) is not always reflected in the promotions run by retailers. Often, the promotions run by retailers constitute only the available (e.g., publically known) information regarding how a manufacturer may be promoting its products. For example, a manufacturer of a soft drink (e.g., Pepsi®) may promote one of its products (e.g., two liter containers of Pepsi®) via a half-off sale. Retailers may combine the promoted product with another related product (e.g., six packs of twelve ounce cans of Pepsi®, two liter containers of Coca-Cola®, or other soft drinks) to form a promotion of wider scope. A modeling group generated using an advertisement for such a promotion would not accurately gauge the manner in which the manufacturer (e.g., Pepsi®) promoted the soft drink.

While the manufacturers could provide consumer activity entities with information related to how the manufacturers promote their products, such a process would likely be inefficient given the large number of manufacturers, amount of promotional information, promoted products, etc. Moreover, manufacturers are often unwilling to provide such information. Therefore, many systems and/or processes that evaluate the promotional strategies of one or more manufacturers make use of publically available data such as advertisements run by retailers.

The example methods, apparatus, systems, and articles of manufacture described herein can be used to automatically create modeling groups for use in large scale promotion response modeling systems. In some examples, the example methods, apparatus, systems, and articles of manufacture described herein enable a mutually exclusive, exhaustive grouping of active products (e.g., products associated with an active Universal Product Code (UPC)) using publically available information. That is, instead of the estimations and extrapolations of certain data in conventional systems, the example methods, apparatus, systems, and articles of manufacture described herein may be used to systematically group the active products into modeling groups (sometimes referred to herein as promoted product groups (PPGs) according to a set of rules

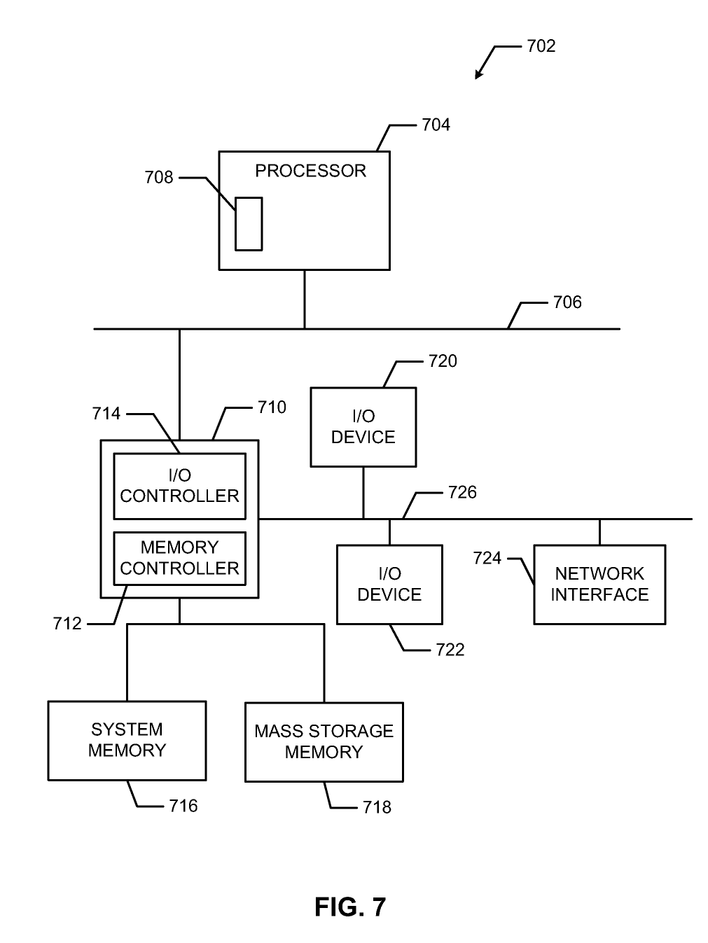

Generally, the example methods, apparatus, systems, and articles of manufacture described herein collect, receive and/or detect information or data associated with the active products of a marketplace and process the data using an example modeling group algorithm implemented by, for example, a processor system (e.g., the example processor system 702 of FIG. 7). The data associated with the active products of the marketplace include, for example, advertisement data (e.g., advertisements associated with a promotional event and/or feature prices of the advertised products), product characteristic data, (e.g., brand name, base description, size, pack size, UPC, base price, etc.), and point of sale (POS) data. An example modeling group algorithm described in greater detail below uses the data associated with the active products to generate modeling groups of products that are homogeneous with respect to price, product type, and promotion scheduling for purposes of informative and/or predictive modeling and/or any other analysis of the impact of one or more promotions.

The modeling groups created by the example methods, apparatus, systems, and articles of manufacture described herein can be used by, for example, a retailer to optimally (e.g., to maximize product sales and/or revenue) place, locate, schedule, and/or, more generally, plan one or more promotions in a retail space by utilizing promotional impact data calculated using the modeling groups. Additionally or alternatively, the methods, apparatus, systems, and articles of manufacture described herein can be used to determine the likely merchandizing promotional strategy of one or more manufacturers based on retailer activity (e.g., promotional activity) without having to obtain the actual promotion strategy details and/or records from each manufacturer.

The minimization of human intervention involved in the example generation of modeling groups described herein significantly reduces or eliminates the effects of analyst error and bias. In particular, many of the subjective conclusions that introduce inconsistencies into the modeling groups of current systems are eliminated in the examples described herein. Instead, the example methods, apparatus, systems, and articles of manufacture described herein utilize a unified, consistent set of rules to create homogeneous (e.g., with respect to price, product type, and promotional scheduling) modeling groups.

Further, the current limits on scope of product coverage are significantly reduced or eliminated by the examples described herein. In particular, due to the automation of the example processes described herein, the resulting modeling groups are mutually exclusive and, in some examples, exhaustive. That is, instead of estimating and extrapolating based on a segment of the marketplace, most active products, if not every active product, are assigned to a modeling group using the example methods, apparatus, systems, and articles of manufacture described herein.

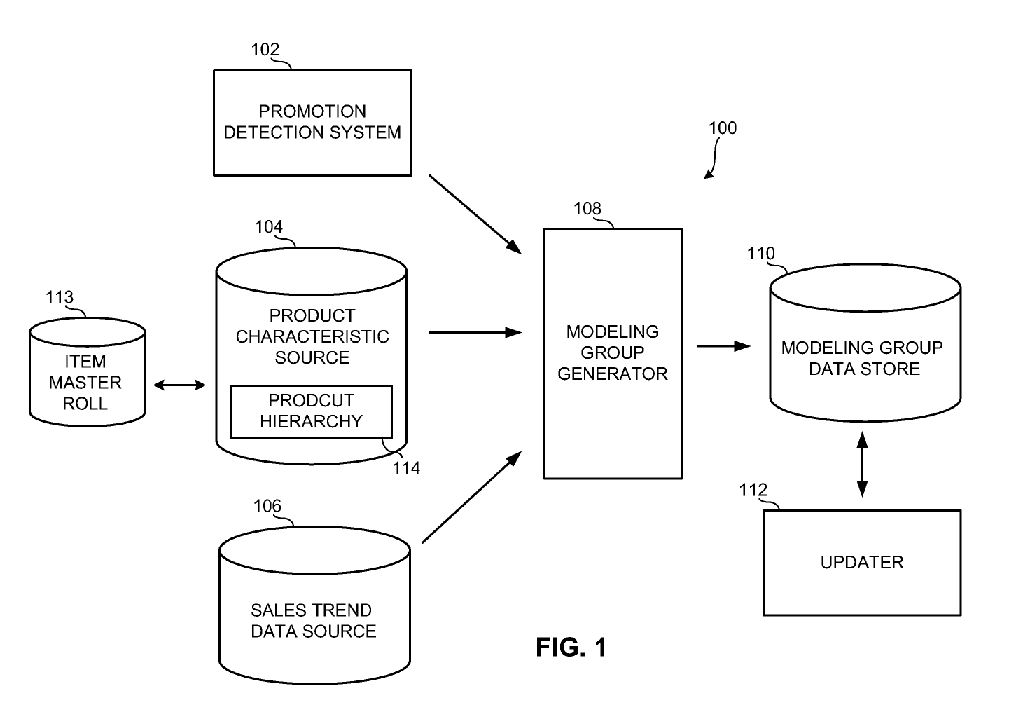

FIG. 1 is a block diagram of an example promotion response modeling system 100. The modeling system 100 includes an example promotion detection system 102, an example product characteristic source 104, an example sales trend data source 106, an example modeling group generator 108, an example modeling group data store 110, and an example updater 112. The modeling system 100 may be used to analyze and/or utilize consumer activity data associated with one or more promotions of a particular product for a particular period of time. For example, to optimize a return on a promotional investment, a business (e.g., using one or more marketing or consumer activity professionals) may employ the example modeling system 100 of FIG. 1 to predict an impact on sales given a certain set of characteristics (e.g., product type, date and time, market conditions, etc.) associated with a potential product promotion. Marketing strategies, budgets, and/or projections can then be adjusted according to the promotion response models generated by the example modeling system 100.

The example promotion detection system 102 of FIG. 1 gathers information related to product promotions such as, for example, sales, discounts, free gifts with purchases, contests, coupon offerings, etc. In the illustrated example, the promotion detection system 102 retrieves advertisements (or features) from a plurality of sources (e.g., newspapers, webpages, servers, databases, catalogs, magazines, television, emails, mailers, etc.) to gather promotional information. As used herein, the terms “advertisement” and “feature” refer to any type of communication regarding any type of promotion or similar event made by any type of entity such as, for example, a retailer. The example promotion detection system 102 of FIG. 1 identifies the product(s) featured in the retrieved advertisement(s), along with aspect(s) of the product(s) and/or promotion(s) associated therewith. In particular, the example promotion detection system 102 of FIG. 1 determines what product(s) are featured in each advertisement and stores the UPC(s) associated with the product(s) identified in each advertisement. Further, the example promotion detection system 102 of FIG. 1 determines the featured price(s) of the product(s) and stores the same. Additionally or alternatively, the example promotion detection system 102 may detect the pack size(s), the brand name(s), and/or the date(s), duration(s), and/or types of the corresponding promotion(s).

In the illustrated example, the promotional information stored in the promotion detection system 102 is gathered by a team of panelists analyzing a plurality of advertisements. For example, a newspaper advertisement representing a buy-one-get-one-free promotion at a grocery store may be collected and analyzed by a panelist. In such instances, the panelist identifies the products, the corresponding promotional prices, and the UPCs assigned to the identified products. Because certain products are available in a plurality of flavors and/or versions, multiple UPCs are often identified for one advertised product. For example, if an advertisement includes a promotion (e.g., fifty percent off) for Gatorade®, the panelist identifies all UPCs (e.g., the UPC corresponding to orange flavored Gatorade®, the UPC corresponding to lemon lime flavored Gatorade®, etc.) associated with regular Gatorade®. In some examples, to obtain the UPCs corresponding to identified products, the panel member enters an identifier (e.g., a brand name) associated with the identified products into, for example, an automated lookup table including a list of product-UPC correlations. Panel members then record the gathered information on, for example, a memory of the promotion detection system 102.

The promotion detection system 102 may obtain promotional information in additional or alternative manners. For example, a database of advertisements and/or any other promotion-related data may be referenced to gather at least a segment of the promotional information. In other examples, advertisements having bar codes (or other identifiers capable of being electronically read), such as coupons, can be scanned to convey an electronic signal containing the product-related and/or promotional information described above to a memory of the promotion detection system 102 and/or another memory (e.g., flash memory) capable of transferring its contents to the promotion detection system 102.

The example product characteristic source 104 contains product characteristic data including, for example, brand information, product types (e.g., categories of products to which the corresponding products belong), base descriptions, base sizes, base pack sizes, and/or base prices (e.g., in descriptions strings associated with the corresponding product codes). In the illustrated example, the product characteristic source 104 contains at least some characteristic data (e.g., brand names at a minimum) for the active products (e.g., each product having an active UPC) available for sale in a marketplace (e.g., a regional marketplace, a national marketplace, an international marketplace, a virtual marketplace, etc.). In the illustrated example, the product characteristic source 104 stores the product characteristic data in association with a corresponding UPC, which acts as an entry number (e.g., a lookup table value) in a database maintained by the product characteristic source 104. The product characteristic data can be indexed and/or stored in additional or alternative manners.

In some examples, the product characteristic source 104 may reference and/or include more than one source of product data. For example, an item master roll 113 managed by, for example, a third party may be referenced by the product characteristic source 104 to obtain information associated with the products. The item master roll 113 may be periodically or aperiodically updated to reflect current marketplace conditions and, in some examples, all of the products offered for sale. Additionally or alternatively, the product characteristic source 104 may reference an internal source (e.g., a source maintained within the same entity employing and/or implementing the modeling system 100) of product information. For example, the modeling system 100 may include a database dedicated to storing data associated with the currently available products as registered by, for example, manufactures, advertisers, retailers, or any other entity interested in registering a product with such a data source.

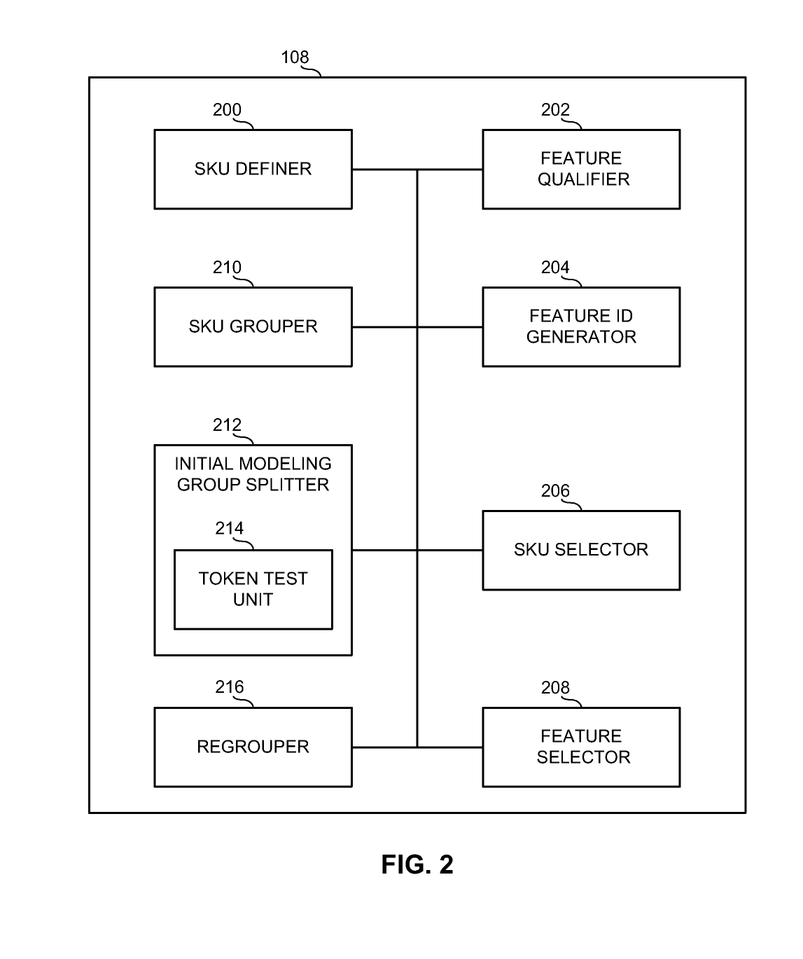

Additionally, the example product characteristic source 104 of FIG. 1 includes a product hierarchy 114, which organizes products (e.g., using UPCs as reference numbers) according to, for example, brand aggregation levels. The example product hierarchy 114 of FIG. 1 is generated and maintained by a consumer activity measurement entity (e.g., A.C. Nielsen®). However, the product hierarchy 114 may be obtained from any other suitable source. Additionally, different aspects of the example product hierarchy 114 of FIG. 1 may vary from other product hierarchies. For example, different product hierarchies may include different levels, numbers of levels, etc. The brand aggregation levels of the example product hierarchy 114 reflect the parent-child relationships between products. For example, a top or high brand (e.g., Miller®) may be the parent to a plurality of bottom or low brands (e.g., Miller Lite®, Miller Genuine Draft®, Miller Genuine Red®, and Miller High Life®). As described in greater detail below in connection with FIG. 2, the brand aggregation levels are referenced and/or otherwise utilized (e.g., by the modeling group generator 108) to maintain the homogeneity of the modeling groups.

The example sales trend data source 106 of FIG. 1 provides point-of-sale (POS) data related to active (or non-active) products. In the illustrated example, the sales trend data source 106 is implemented by a third party data collection system or warehouse such as, for example, Neteeza®. Sales information (e.g., regional, national or international sales statistics) is collected from a plurality of retailers and/or other sources to track product performance and/or any other information of interest. The POS data of the sales trend data source 106 includes, for example, pricing information (e.g., base price, sold price, pack price, price per item, etc.), the corresponding UPC of a product, UPCs of other products sold in the same transaction, a time and date of the transaction, the business name and location at which the transaction took place, etc.

The example modeling group generator 108 receives the information described above from the promotion detection system 102, the product characteristic source 104, and the sales trend data source 106 and uses some or all of this data to create a plurality of modeling groups. In particular, the example modeling group creator 108 systematically processes the data received from the promotion detection system 102, the product characteristic source 104, and the sales trend data source 106 according to a set of rules. The example set of rules described herein produces a plurality of definitions corresponding to the resulting modeling groups. The rules are configured such that the modeling groups represent groups of products that are promoted together (e.g., occurring in the same advertisement or feature) and are of similar product types (e.g., according to product category assignment in the product characteristic data source 104).

The modeling groups are homogeneous with respect to pricing, product type, and promotional scheduling. In some examples, the modeling groups are mutually exclusive and exhaustive in that the modeling groups collectively cover the active products on a marketplace (e.g., a regional marketplace, a national marketplace, an international marketplace, a virtual marketplace, etc.). The modeling groups can then be used to analyze trade promotion impacts and/or the promotional strategies of, for example, product manufacturers without having to actually obtain promotional records from manufacturers of the products. An example implementation of the modeling group generator 108 is described below in connection with FIG. 2.

The modeling group definitions are stored in the example modeling group data store 110. Additionally, or alternatively, the modeling group definitions can be assigned as an attribute in association with the UPCs (or stock keeping units (SKUs) including the UPCs) corresponding to products of the modeling groups. In the illustrated example, the modeling group data store 110 is a database implemented on a processor system (e.g., the processor system 702 of FIG. 7). The data store 110 stores the modeling group definitions in association with a time and date at which the definitions were generated. Further, a historical mapping of the modeling groups for both active and inactive UPCs is maintained in the data store 110. The historical mapping enables a user to recreate previous models from previous periods of time.

The example modeling group data store 110 of FIG. 1 is periodically or aperiodically accessed by the updater 112 to determine whether the modeling group definitions are out dated. For example, the updater 112 may obtain the most recent time and date associated with the definitions stored at the data store 110 and compare the same to a current time and date. If the period of time between the most recently generated definition and the current time and date exceeds a threshold, the example updater 112 of FIG. 1 determines whether an update to the modeling system 100 is necessary.

In particular, the updater 112 determines whether any UPCs considered during the last execution of the modeling system 100 have changed, whether there are any new UPCs (e.g., UPCs activated since the last execution of the modeling system 100), and whether any UPCs considered during the last execution of the modeling system 100 have been deleted. If any changes, additions, deletions, etc. are identified, the updater 112 causes the modeling group generator 108 to perform one or more of its functions described herein on a different set of data including, for example, additional or alternative products, promotions, and/or sales information. Specifically, if any new or different UPCs are identified by the updater 112, those UPCs are processed to be homogeneously grouped according to the set of rules described herein. In the illustrated example, a new or different UPC having identical characteristics (e.g., brand name, base size, base pack size, and base description) as the characteristics of the products of an existing modeling is added to the existing modeling group. If the product associated with the updated UPC fits into more than one modeling group, the UPC is collapsed into the modeling group having the highest pricing data (e.g., according to the POS data from the sales trend data source 106). If the product associated with the updated UPC does not fit into an existing modeling group, the UPC is processed by the modeling group generator 108 as described in greater detail below.

FIG. 2 is a block diagram of an example apparatus that may be used to implement the example modeling group generator 108 of FIG. 1. In the illustrated example of FIG. 2, the example modeling group generator 108 includes an SKU definer 200, a feature qualifier 202, a feature identification (ID) generator 204, an SKU selector 206, a feature selector 208, an SKU grouper 210, an initial modeling group splitter 212, a token test unit 214, and a regrouper 216. While an example manner of implementing the modeling group generator 108 of FIG. 1 has been illustrated in FIG. 2, one or more of the elements, processes and/or devices illustrated in FIG. 2 may be combined, divided, re-arranged, omitted, eliminated and/or implemented in any other way. Further, the example SKU definer 200, the example feature qualifier 202, the example feature ID generator 204, the example SKU selector 206, the example feature selector 208, the example SKU grouper 210, the example initial modeling group splitter 212, the example token test unit 214, the example regrouper 216, and/or, more generally, the example modeling group generator 108 of FIG. 2 may be implemented by hardware, software, firmware and/or any combination of hardware, software and/or firmware. Thus, for example, any of example SKU definer 200, the example feature qualifier 202, the example feature ID generator 204, the example SKU selector 206, the example feature selector 208, the example SKU grouper 210, the example initial modeling group splitter 212, the example token test unit 214, the example regrouper 216, and/or, and/or, more generally, the example modeling group generator 108 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example SKU definer 200, the example feature qualifier 202, the example feature ID generator 204, the example SKU selector 206, the example feature selector 208, the example SKU grouper 210, the example initial modeling group splitter 212, the example token test unit 214, the example regrouper 216, and/or, and/or, more generally, the example modeling group generator 108 of FIG. 2 are hereby expressly defined to include a tangible, computer-readable medium such as a memory, DVD, CD, etc. storing the software and/or firmware. Further still, the example modeling group generator 108 of FIG. 2 may include one or more elements, processes and/or devices in addition to, or instead of, those illustrated in FIG. 2, and/or may include more than one of any or all of the illustrated elements, processes and devices.

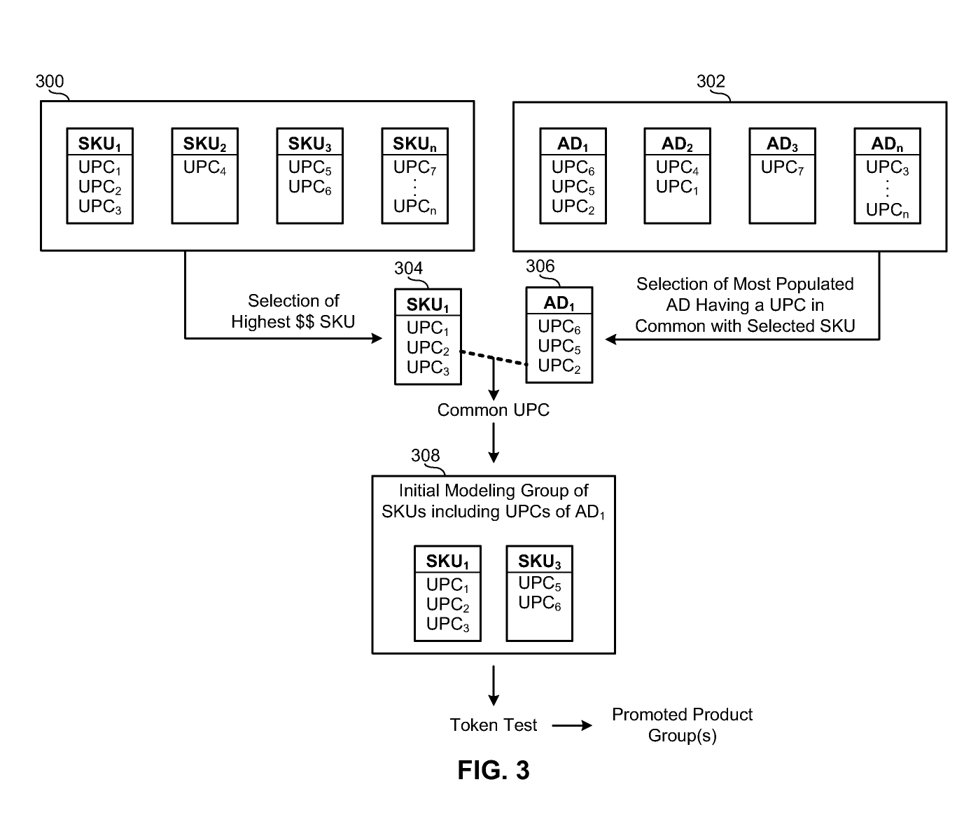

FIG. 2 is described below in conjunction with FIG. 3, which illustrates an example generation of modeling group(s) by the example modeling group generator 108. FIG. 3 is meant for illustrative purposes and does not limit the example modeling group generator 108 to the illustrated example.

The example SKU definer 200 of FIG. 2 loops or cycles through the active UPCs until each UPC (e.g., of a defined marketplace) is included in one of a plurality of SKU definitions that define the SKUs. More generally, the example SKU definer 200 produces a plurality of SKUs, each including a plurality of UPCs assigned to similar products (e.g., retail units having identical or substantially similar characteristics). The SKUs are sometimes referred to herein as product groups. An example set of SKUs 300 is illustrated in FIG. 3.

To define an SKU, the example SKU definer 200 uses the product characteristic information received from the product characteristic source 104 (FIG. 1) to group products having similar characteristics. In the illustrated example, the product characteristics used to define an SKU include base description, base size, and base pack size. However, additional and alternative product characteristic information is available and may be used in other examples to define an SKU. Regarding the base size, a certain soft drink may be available in two liter bottles, sixteen ounce bottles, or twelve ounce cans. Regarding the base pack size, units of the soft drink may be available in packs of one, four, six, twenty four, etc. Each retail unit of differing base size and base pack size of the soft drink has a different UPC assigned thereto. In other words, twelve ounce cans of the soft drink are assigned a different UPC than the UPC assigned to sixteen ounce bottles of the soft drink. Further, six packs of the soft drink are assigned a different UPC than the UPC assigned to twenty four packs of the soft drink.

In some examples, the base size and base pack size can be obtained from the base description. For example, the base description may comprise a text field including the text “six_pack_of_twelve_ounce_cans_of_Pepsi.” In other examples, the base description may contain a brand name (e.g., Pepsi®) without any indication of the base size and/or base pack size. In such instances, the base size and/or base pack size can be obtained from the product characteristic source 104.

The example SKU definer 200 groups UPCs that are assigned to similar retail units, but that may differ as a result of, for example, promotional alterations to size, pack size, and/or labeling. For example, a “buy one get one free” promotion may include providing a seventh, free can of the soft drink with the typical six pack. Another example includes providing an extra four ounces of the soft drink in addition to the typical sixteen ounce bottles. In such instances, the labeling of the promotional item typically indicates that the consumer will be receiving an extra amount of product at no extra cost (e.g., “Twenty ounces for the price of sixteen”). Such promotional items have the same base size and base pack size of their standard product counterparts. However, the promotional items are assigned different UPCs than their standard product counterparts. The example SKU definer 200 groups the promotional items together with their standard product counterparts to form an SKU of common base sizes, base pack sizes, and base descriptions.

Another example reason for different UPCs being assigned to similar retail units is that labeling requirements vary between jurisdictions (e.g., states, countries, etc.) to the next. For example, certain facts about products are required to be placed on labels in some states or countries but not in others. In such instances, the same product (e.g., a six pack of twelve ounce cans of Pepsi®) is assigned different UPCs depending on a state of, for example, distribution or manufacture. The example SKU definer 200 groups the varying UPCs together with their jurisdictional counterparts to form an SKU of common base sizes, base pack sizes, and base descriptions.

The example feature qualifier 202 receives information from the promotion detection system 102 (FIG. 1) and determines whether the corresponding features (e.g., advertisements) qualify for consideration by the modeling group generator 108. Specifically, the example feature qualifier 202 of FIG. 2 compares the feature price of an advertised product to the base price (e.g., the standard, non-promotional price) of the product. In the illustrated example, the feature price is provided by the panel members entering information into the promotion detection system 102 and the base price is provided by the product characteristic source 104. If a difference calculated by the example feature qualifier 202 does not meet or exceed a predetermined threshold (e.g., a percentage of the base price, such as five percent), the feature qualifier 202 discards the corresponding promotional information. Otherwise, the feature qualifier 202 conveys the corresponding promotional information to the example feature ID generator 204.

The example feature ID generator 204 of FIG. 2 generates a plurality of feature identifiers having information coded therein capable of representing the UPCs assigned to products appearing in the qualifying advertisements. More generally, the example feature ID generator 204 produces a plurality of feature identifiers, each including a plurality of UPCs assigned to products of an advertisement (or feature). An example set of feature identifiers 302 is illustrated in FIG. 3.

The example feature ID generator 204 receives data associated with qualifying advertisements (or features) and assigns feature identifiers to these qualifying advertisements. As described above, panel members entering data into the promotion detection system 102 determine (e.g., via an electronic lookup table) the UPCs corresponding to the products appearing in the analyzed advertisements. For a first advertisement, the example feature ID generator 204 generates a first feature identifier having information coded therein capable of representing all of the UPCs assigned to products appearing in the first advertisement. In the illustrated example, the first feature identifier associated with the first advertisement is a hash value. However, other examples may include additional or alternative systems or methods for generating feature identifiers.

Once the example feature ID generator 204 has processed the first advertisement, a second feature or advertisement is analyzed. If the second advertisement includes the same promotional products as the first advertisement (e.g., the corresponding UPCs are identical), the example feature ID generator 204 assigns the same feature identifier to the second advertisement as was assigned to the first advertisement. Otherwise, if the products appearing in the second advertisement differ from the products of the first advertisement, the example feature ID generator 204 creates and assigns a second feature identifier to the second advertisement. The example feature ID generator 204 loops through the advertisements received since the last time the modeling group generator 108 was run until each advertisement is assigned a feature identifier. Thus, the example feature qualifier 202 and the feature ID generator 204 of FIG. 2 cooperate to create a set of feature identifiers, each of which represents a qualified advertisement and the products featured or promoted therein. While the feature ID generator 204 is shown as implemented by the modeling group generator 108 in the illustrated example, the feature ID generator 204 and/or its functionality may be implemented elsewhere (e.g., in the promotion detection system 102) in some examples.

The example SKU selector 206 selects one of the plurality of SKUs defined by the SKU definer 200 to be processed (e.g., by the SKU grouper 210 as described below). FIG. 3 depicts a first SKU 304 as being selected by the example SKU selector 206. In the illustrated example, the SKU selector 206 selects the unprocessed SKU having the highest dollar importance as indicated by the POS data received from the sales trend data source 106 (FIG. 1). The dollar importance of an SKU is measured by the amount of revenue produced by the sale of each product within the SKU. Thus, the example SKU selector 206 selects the remaining (e.g., unprocessed) SKU associated with the highest selling products (e.g., by revenue). The example SKU selector 206 may use additional or alternative criteria when selecting the SKUs for processing.

The example feature selector 208 selects one of the plurality of feature identifiers generated by the feature ID generator 204 to be processed (e.g., by the SKU grouper 210 as described below). FIG. 3 depicts a first feature identifier 306 as being selected by the example feature selector 208. In the illustrated example, where the feature identifiers are implemented in hash values, the feature selector 208 analyzes the hash values to identify UPCs of the feature identifiers that are also present in the selected SKU (e.g., the selected SKU 304 of FIG. 3). That is, the feature selector 208 determines which of the advertisements corresponding to the feature identifiers include at least one product associated with the UPCs of the selected SKU.

For instances in which the products of the selected SKU are not featured in any of the advertisements analyzed by the promotion detection system 102, the feature selector 208 marks the selected SKU as unfeatured. Unfeatured SKUs are processed after the featured SKUs are assigned to modeling groups as described below. In some instances, more than one feature identifier includes products associated with the UPCs of the selected SKU. If so, the example feature selector 208 of FIG. 2 selects the unprocessed feature identifier having the most UPCs (e.g., the most featured products).

The example SKU grouper 210 receives the selected feature identifier (e.g., the selected feature identifier 306 of FIG. 3) corresponding to the selected advertisement. The example SKU grouper 210 creates initial modeling group(s) by grouping together the SKU(s) corresponding to the product(s) of substantially similar type(s) appearing in the selected advertisement. In particular, the example SKU grouper 210 identifies the UPCs associated with the selected advertisement or feature identifier (e.g., as provided by the promotion detection system 102 of FIG. 1 and the feature ID generator 204) and determines to which SKU each of the identified UPC(s) has been assigned (e.g., by the SKU definer 200). The SKUs including the UPCs corresponding to products of substantially similar type(s) that appear in the selected advertisement are combined to form the initial modeling group(s). The product type can be determined by referencing and/or accessing certain categorical values provided by the product characteristic data source 104.

For example, if the selected advertisement includes a fifty-percent-off promotion for twenty four packs of twelve ounce cans of Miller®, Miller Lite®, Miller Genuine Draft®, Miller Genuine Draft Light®, Miller Genuine Red®, Miller High Life®, Miller High Life Ice®, Miller High Life Light®, Budweiser®, and Bud Light®, the example SKU grouper 210 identifies which SKU definition includes the UPC corresponding to Miller Lite®, which SKU definition includes the UPC corresponding to Miller Genuine Draft®, and so on, for each of the above-mentioned products. When the featured products are of a similar category (e.g., beer), the example SKU grouper 210 then creates an initial modeling group that includes the identified SKUs. When the selected advertisement includes products of different categories, the SKU grouper 210 creates separate initial modeling groups that include the SKUs of those categories. The example SKU grouper 210 of FIG. 2 creates the groupings by assigning an initial modeling group number to the UPCs corresponding to the products of the grouped SKUs. As described in greater detail below, the initial modeling group may or may not be subsequently altered by the token test unit 214 to form final modeling group(s).

In the example of FIG. 3, an initial modeling group 308 includes the SKUs having the UPCs of the selected feature identifier 306 assigned thereto. As described above, the selected feature identifier 306 was selected in response to determining that the selected feature identifier 306 included at least one of the UPCs in the selected SKU 304 and the selected feature identifier 306 was the most populated feature identifier among those including at least one of the UPCs in the selected SKU 304. FIG. 3 shows that the selected feature identifier 306 includes UPC₆, UPC₅, and UPC₂. FIG. 3 also shows that UPC₆ and UPC₅ were assigned to SKU₃ and that UPC₂ was assigned to SKU₁. In the illustrated example, the products corresponding to UPC₆, UPC₅, and UPC₂ are of a substantially similar type. Therefore, the example initial modeling group 308 of FIG. 3 comprises SKU₁ and SKU₃.

Referring back to FIG. 2, the example initial modeling group splitter 212 receives the initial modeling groups and, if certain conditions are met, splits the initial modeling groups into final modeling groups according to brand aggregation levels. As described above, the example product hierarchy 114 (FIG. 1) organizes products (e.g., using UPCs as reference numbers) according to brand aggregation levels, which reflect the parent-child relationships between products. For example, a top brand name refers to the name of a product according to the highest brand aggregation level. For example, Miller® and Budweiser® are top brands for Miller Genuine Draft® and Bud Light®, respectively. In those instances, Miller Genuine Draft® and Bud Light® are referred to as the bottom brands of the respective products. In other examples, the top brand for a product is not solely the first word or term of the bottom brand.

The example initial modeling group splitter 212 of FIG. 2 is configured to split the initial modeling groups according to a brand aggregation level, which can be adjusted in the illustrated example. A brand aggregation level setting to be set in the initial modeling group splitter 212 may be set by the consumer activity measurement entity implementing the example response modeling system 100 based on, for example, client requests and/or a category of product. For example, the desired brand aggregation level for soft drinks may differ from the desired brand aggregation level for frozen dinners. Thus, the brand aggregation level setting can be adjusted depending on the type of product appearing in the selected feature or advertisement. The brand aggregation level setting also has a default value to which the initial modeling group splitter 212 may resort in the absence of more specific instructions.

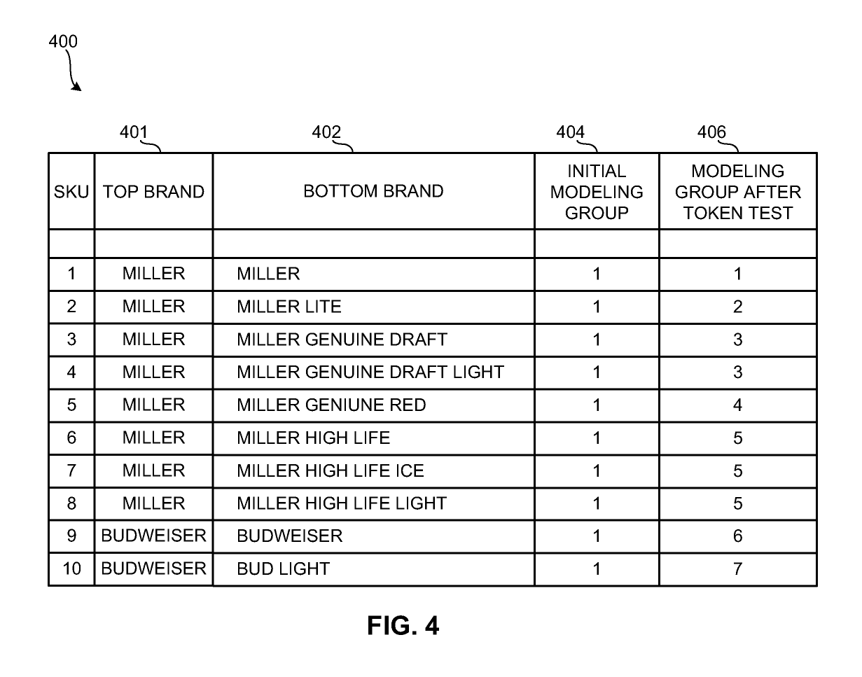

The brand aggregation level setting is conveyed to the example token test unit 214, which is capable of splitting the initial modeling groups to form the final modeling groups described herein. FIG. 4 is a table 400 depicting an example initial modeling group received by the token test unit 214. Specifically, the example initial modeling group includes SKUs corresponding to ten products for which top brands are listed in the column at reference numeral 401 and bottom brands are listed in the column at reference numeral 402. The table 400 shows that the example initial modeling group is assigned a number (e.g., one) as a label in the column at reference numeral 404. The table 400 also shows that the initial modeling group is split into final modeling groups, which are also assigned a label as shown in the column at reference numeral 406. The table 400 may referenced in conjunction with the following description of the token test performed by the example token test unit 214 of FIG. 2.

The example token test unit 214 determines a brand aggregation level at which the different SKUs of an initial modeling group become dissimilar with respect to brand name. With regards to the example token test unit 214, the brand aggregation levels are referred to as having a token value. In the illustrated example, the first brand name, word, or term (which, as described above, may or may not be the top brand of the product) in the full brand name of a product has a token value of one, the second brand name, word, or term has a token value of two, the third has a token value of three, etc. For purposes of illustration, the following is described as the brand level setting from the initial modeling group splitter 212 being set to “top brand plus two.” That is, after the top brand, the next two token values are analyzed and compared. If the brand names of two products match at the “top brand plus two” token value, the corresponding SKUs are grouped together to form final modeling groups. On the other hand, if the brand names of the two products do not match at the “top brand plus two” token value, the corresponding SKUs are split into separate final modeling groups.

In the illustrated example, in response to receiving an initial modeling group (e.g., the initial modeling group (Group 1) listed in the example table 400 of FIG. 4) the token test unit 214 begins with the one-token value for each SKU, comparing the brand name associated with each of the SKUs. The example token test unit 214 proceeds down the brand aggregation levels, ending according to the setting (e.g., three-token) described above. To enable the comparisons described herein, brand names having a token count (e.g., a number of words or terms in the full brand name) less than the brand level setting cause the example token test unit 214 to assign null values to any token level without a word or term, thereby providing the example token test unit 214 something to which other words or terms may be compared.

If the brand-high names (e.g., one-token values) differ between SKUs, separate modeling groups are created therefor. For example, the first SKU of the example table 400 of FIG. 4 has a one-token value of “Miller®” and the ninth SKU has a one-token value of “Budweiser®,” column 406 shows that the first SKU 408 is assigned to final modeling group #1 and the ninth SKU is assigned to final modeling group #6. Otherwise, if the one-token values of SKUs are the same or, in some examples, substantially similar, the example token test unit 214 checks the next brand aggregation level.

If the one-token values of SKUs are the same or, in some example, substantially similar, but the two-token values between the SKUs differ, separate modeling groups are created therefor. For example, the second SKU has a two-token value of “Miller Lite®” and the third SKU has a two-token value of “Miller Genuine®,” column 406 shows that the second SKU is assigned to final modeling group #2 and the third SKU is assigned to final modeling group #3. Otherwise, if the two-token values of SKUs are the same or, in some examples, substantially similar, the example token test unit 214 checks the next brand aggregation level.

If the one-token values and the two-token values of SKUs are the same or, in some examples, substantially similar, but the three-token values of SKUs differ, separate modeling groups are created therefor. For example, because the third SKU has a three-token value of “Miller Genuine Draft®” and the fifth SKU has a three-token value of “Miller Genuine Red®,” column 406 shows that the third SKU is assigned to final modeling group #3 and the fifth SKU is assigned to final modeling group #4. Otherwise, if the three-token values of SKUs are the same or, in some examples, substantially similar, the example token test unit 214 checks the next brand aggregation level.

If the one-token values, the two-token values, and the three-token values of SKUs are the same or, in some examples, substantially similar, the SKUs are assigned to the same final modeling group. For example, because the third SKU has a three-token value of “Miller Genuine Draft®” and the fourth SKU has a three-token value of “Miller Genuine Draft®,” column 406 shows that the third SKU and the fourth SKU are assigned to final modeling group #3. In another example, because the sixth, seventh, and eighth SKUs have a three-token value of “Miller High Life®,” column 406 shows that the sixth, seventh, and eighth, SKUs are assigned to final modeling group #5.

The example token test unit 214 performs these comparisons at the set token level until each SKU of the initial modeling group has been compared to all of the other SKUs in the initial modeling group. The result is one or more modeling groups that can be utilized in one or more trade promotion response models as described above. In the illustrated example, the modeling group assignments are tracked by assigning a final modeling group number to each of the products (e.g., the corresponding UPC information) in a particular modeling group.

After the modeling groups are created for the first initial modeling group, which was generated after selecting the SKU (e.g., via the SKU selector 206) with the highest dollar importance (e.g., highest revenue associated with the corresponding products according to POS data), the SKU having the next highest dollar importance is selected for processing. However, if that SKU (or the products assigned thereto) has already been assigned to a modeling group during the first iteration described above, the SKU selector 206 selects the next highest dollar SKU, thereby skipping the SKU that has already been assigned to a modeling group.

As described above, unfeatured SKUs (e.g., as marked by the feature selector 208) are processed after the featured SKUs. Specifically, the unfeatured SKUs are grouped by the SKU grouper 210 according to product type, a bottom brand name, and base pack size and size. In the illustrated example, the initial modeling groups created by the SKU grouper 210 for the unfeatured SKUs are not conveyed to the token test unit 214. Rather, the initial modeling groups created by the SKU grouper 210 are credited as final modeling groups or PPGs.

The example regrouper 216 then determines whether any modeling groups should be regrouped to avoid redundancies and/or overlapping of the modeling groups. The creation of the modeling groups as described herein may result in two or more modeling groups including products that overlap with regard to, for example, full brand name and base size. For example, the processing of a selected SKU and advertisement as described above may result in a first modeling group that includes UPCs associated with 64-96 oz. Tropicana Orange Juice®. In that case, the processing of another selected SKU and another advertisement as described above may result in a second modeling group that includes a UPC associated with 72 oz Tropicana Orange Juice®. The example regrouper 216 identifies such instances (e.g., via a search of the final modeling groups as generated by the SKU grouper 210 and/or initial modeling group splitter 212) and determines whether the first and second modeling groups should be regrouped according to a set of rules.

The overlapping of base sizes and full brand names of the example orange juice products make the corresponding modeling groups candidates for regrouping. In the illustrated example, the regrouper 216 determines that two overlapping modeling groups are to be regrouped if the second modeling group (e.g., the modeling group associated with the product that falls into the range of the first modeling group with respect to base size) has a lower dollar importance (e.g., less revenue associated with the SKUs of the modeling group) than the first modeling group. In such instances, the UPCs of the second modeling group are added to the first modeling group and, in some examples, the second modeling group is deleted. As described herein, records of the deleted modeling group are kept in the modeling group data store 110 in a historical mapping. In other examples, the second modeling group is completely erased. If the second modeling group has an equal or higher dollar importance compared to the first modeling group, the first and second modeling groups are not regrouped.

Regarding irregular instances of products, if a UPC is associated with incomplete information (e.g., a brand cannot be identified in the current contents of the product characteristic data source 104), the example modeling group generator 108 creates a modeling group dedicated to the individual product corresponding to the incomplete UPC. Further, if the set of active products analyzed by the modeling system 100 includes products of unrecognized brands (e.g., a private label not included in the current contents of the product hierarchy 114), the example token test unit 214 does not split the initial modeling group created for such products.

This process repeats until the SKU selector 206 has selected the SKU with the lowest dollar importance. Thus, in the illustrated example, the modeling group generator 108 creates a plurality of exhaustive, mutually exclusive modeling groups that are homogeneous with respect to pricing, product type, and promotional scheduling.

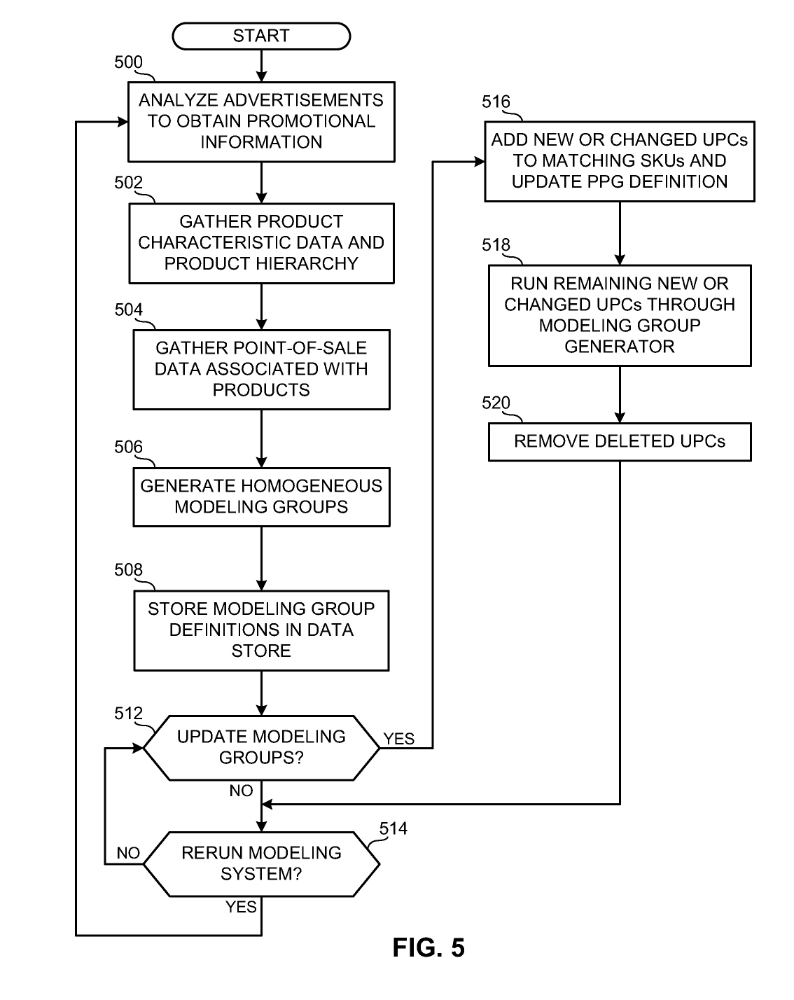

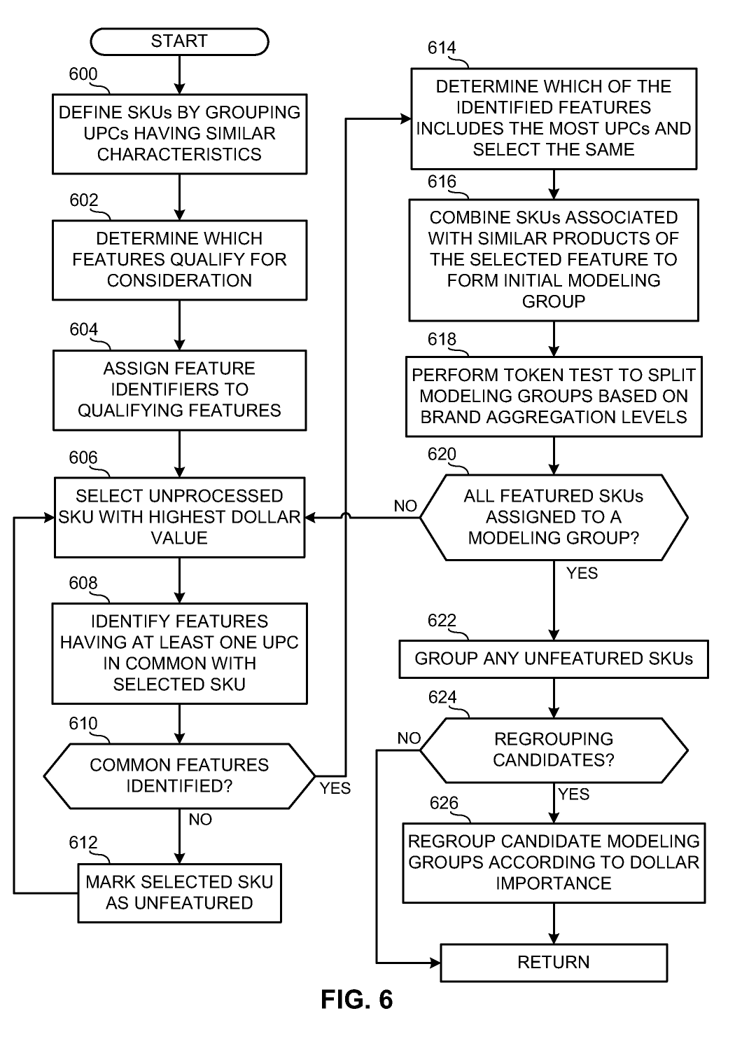

The flow diagrams depicted in FIGS. 5 and 6 are representative of example methods that can be performed to implement the examples described herein. The example methods of FIGS. 5 and 6 may be performed using a processor, a controller and/or any other suitable processing device. For example, the example methods of FIGS. 5 and 6 may be implemented as coded instructions stored on a tangible medium such as a flash memory, a read-only memory (ROM) and/or random-access memory (RAM) associated with a processor (e.g., the example processor 704 discussed below in connection with FIG. 7). Alternatively, some or all of the example operations of FIGS. 5 and 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, one or more of the example operations of FIGS. 5 and 6 may be implemented manually or as any combination(s) of any of the foregoing techniques, for example, any combination of firmware, software, discrete logic and/or hardware. Further, although the example methods of FIGS. 5 and 6 are described with reference to the flow diagrams of FIGS. 5 and 6, other methods of implementing the methods of FIGS. 5 and 6 may be employed. For example, the order of execution of the blocks may be changed, and/or some of the blocks described may be changed, eliminated, sub-divided, or combined. Additionally, any or all of the example operations of FIGS. 5 and 6 may be performed sequentially and/or in parallel by, for example, separate processing threads, processors, devices, discrete logic, circuits, etc.

FIG. 5 is a flow diagram representative of an example method that may be performed to implement the example modeling system 100 of FIG. 1 to create modeling groups for use in trade promotion response models. A consumer metering entity, retail business, marketing professional, and/or any other entity interested in understanding consumers activity can utilize the example method of FIG. 5 to create a plurality of modeling groups (e.g., exhaustive, mutually exclusive modeling groups) that are homogeneous with respect to, for example, pricing, product type, and promotional scheduling. The modeling groups can then be utilized to analyze and/or predict the impact of certain promotions on product sales performance.

To provide data to the example modeling group generator 108 (FIG. 1), a plurality of information sources are activated and/or accessed. In the example of FIG. 5, one or more advertisements are analyzed to obtain data related to the promotion of active products (block 500). In the illustrated example, the promotion detection system 102 (FIG. 1) gathers the advertisements from sources including, for example, newspapers, webpages, catalogs, magazines, television, emails, and/or mailers. Using the advertisements, a panel of analysts determines what product(s) are featured in each advertisement, the featured price(s) of the product(s), and the UPC(s) assigned to the feature product(s). Additionally or alternatively, the promotion detection system 102 may detect the pack size(s), the brand name(s), and/or the date(s), duration(s), and/or types of the corresponding promotion(s). In the illustrated example, to obtain the UPCs corresponding to identified products, a panelist can enter an identifier (e.g., a brand name or a reading from a bar code) associated with identified products into an automated lookup table including a list of product-UPC correlations. The panelists then record the gathered information into, for example, a database capable of storing the promotional information. The promotional information is subsequently used by the modeling group generator 108 (FIG. 1) to group products (e.g., using the corresponding UPCs defined in an SKU) being similarly promoted and/or featured in an advertisement.

Another source of information that provides data to the modeling group generator 108 is the product characteristic source 104 (FIG. 1). The product characteristic data source 104 includes product characteristic data such as, for example, brand information, base descriptions, base sizes, base pack sizes, and/or base prices. Additionally, the product characteristic data source 104 includes the product hierarchy 114, which organizes (e.g., using UPCs as reference numbers) according to, for example, brand aggregation levels. In the illustrated example, the product characteristic data and product hierarchy information is gathered to be provided to the modeling group generator 108 (block 502). The example modeling group generator 108 of FIG. 1 uses the product characteristic data to define (e.g., via the SKU definer 200 of FIG. 2) one or more SKUs to individually include one or more UPCs associated with similar products. As described above, similar products (e.g., products having identical base descriptions, base sizes, and/or base pack sizes) are often assigned different UPCs due to for example, promotional alterations to size, pack size, and/or labeling and/or different local labeling requirements. Further, the example modeling group generator 108 of FIG. 1 uses the product hierarchy information to split initial modeling groups (e.g., via the token test unit 214 of FIG. 2) according to brand aggregation levels.

Another source of information that provides data to the modeling group generator 108 is the sales trend data source 106 (FIG. 1). In the illustrated example, the sales trend data source 106 provides POS data related to active (or non-active) products (block 504). The POS data of the sales trend data source 106 includes, for example, pricing information (e.g., base price, sold price, pack price, price per item, etc.), the corresponding UPC of a product, UPCs of other products sold in the same transaction, a time and date of the transaction, the business name and location at which the transaction place, etc. Among other uses, the example modeling group generator 108 uses the sales trend data to determine which SKUs are of the highest dollar importance (e.g., the SKUs including the products that generate the most revenue).

In the illustrated example, the information provided by the promotion detection system 102, the product characteristic source 104, the product hierarchy 114, and/or the sales trend data source 106 is updated weekly. However, other examples may update the information provided by such sources more or less often. Once these information sources (the promotion detection system 102, the product characteristic source 104, the sales trend data source 106, and the product hierarchy 114) have provided the data described above to the modeling group generator 108, the corresponding products and features (e.g., advertisements) are processed (e.g., exhaustively) by the modeling group generator 108 to create a plurality of homogeneous (e.g., with respect to price, promotional scheduling, and/or product type) modeling groups (block 506). This process is described in greater detail below in connection with FIG. 6.

In the illustrated example, the modeling group generator 108 processes the products and features until each SKU and, thus, each active UPC is assigned to a modeling group. A plurality of PPG definitions indicative of the modeling group assignments is stored in the modeling group data store 110 (FIG. 1) (block 508). The PPG definitions may include numbers or labels identifying the modeling groups in conjunction with a list of SKUs assigned to the modeling groups.

Periodically or aperiodically, the PPG definitions are updated to account for UPCs that have changed, been added, or been deleted since the last processing cycle of the modeling system 100. If no such UPCs are detected (e.g., by the search initiated by the example updater 112 of FIG. 1) (block 512), the example updater 112 of FIG. 1 determines whether the modeling system 100 should be run again (block 514). For example, after a certain duration of time (e.g., two months), the entity implementing the example modeling system 100 of FIG. 1 may desire to reprocess all active UPCs as described herein. If so, control returns to block 500.

Otherwise, if changed, new, or deleted UPCs are detected at block 512, or if the modeling system 100 is scheduled for an update process (e.g. a weekly update), the updater 112 prompts one or more components of the modeling group generator 108 to perform one or more of the functions described herein. In particular, new UPCs and the associated product characteristics are compared to the product characteristics of SKUs defined by the SKU definer 200 of FIG. 2. If the product characteristics associated with a new UPC match a SKU definition (e.g., with respect to brand, base size, base pack size, and product category), the UPC is added to that SKU and the modeling group definition assigned to that SKU is updated to include the new UPC (block 516). If the product characteristics associated with a new UPC do not match a SKU definition or do not otherwise fit into an existing modeling group, those UPCs are run through the modeling group generator 108 to determine whether any of the new or changed UPCs can be grouped together to form a modeling group (block 518). Any UPCs that were eliminated or deactivated are removed from the modeling group data store (block 520). Control then returns to block 514.

FIG. 6 is a flow diagram representative of an example method that may be performed to implement the example modeling group generator 108 of FIG. 2. The example method of FIG. 6 is performed until each SKU and, thus, the active UPCs of a marketplace are assigned to a modeling group. However, the example methods, apparatus, systems, and/or articles of manufacture described herein can be used to generate modeling groups of different scale(s) and/or degrees of coverage.

To begin, using the product characteristic information received from the product characteristic data source 104, the example SKU definer 200 of FIG. 2 defines one or more SKUs to include products having similar characteristics (block 600). In the illustrated example, the product characteristics used to define an SKU include base description, base size, and base pack size. The example SKU definer 200 groups UPCs that are assigned to similar retail units, but that may differ as a result of, for example, promotional alterations to size, pack size, and/or labeling and/or varying labeling requirements imposed on manufacturers in different jurisdictions. Such items have the same base size and base pack size, but are assigned different UPCs due to the differences in, for example, size, pack size, or labeling. The example SKU definer 200 groups the altered items together with their standard product counterparts to form an SKU of common base sizes, base pack sizes, and base descriptions. The example SKU definer 200 loops through the active UPCs until each UPC is included in one of the SKU definitions. In this manner, the example SKU definer 200 produces a plurality of SKUs, each including one or more UPCs assigned to similar products (e.g., retail units having identical or substantially similar characteristics).

Next, the features or advertisements received from the promotion detection system 102 (FIG. 1) are qualified by the example feature qualifier 202 of FIG. 2 (block 602). Specifically, the example feature qualifier 202 compares the feature price of an advertised product (e.g., which is provided by the panelists analyzing the feature or advertisement) to the base price of the advertised product (e.g., which is provided by the product characteristic data source 104). If the difference calculated by the example feature qualifier 202 does not meet or exceed a predetermined threshold (e.g., a percentage of the base price, such as five percent), the feature qualifier 202 discards the corresponding promotional information. Otherwise, the feature qualifier 202 conveys the corresponding promotional information to the example feature ID generator 204.

The features or advertisements that are qualified are conveyed to the example feature ID generator 204 of FIG. 2, which assigns feature identifiers to the qualified features according to the UPCs appearing therein (block 604). If two features or advertisements include the same products being similarly promoted, the example feature ID generator 204 assigns each of the similar features the same feature identifier (e.g., to avoid redundancy). In the illustrated example, the feature identifiers generated by the feature ID generator 204 are values (e.g., hash values) representative of each UPC corresponding to each product appearing in the feature or advertisement. The example feature ID generator 204 loops through all features or advertisements received since the last time the modeling group generator 108 was run until each feature or advertisement is assigned a feature identifier.

The SKU definitions and feature identifiers are then used by the example SKU selector 206 and the example feature selector 208 of FIG. 2 to select an SKU and a feature or advertisement. Specifically, the example SKU selector 206 selects the remaining (e.g., not yet assigned to an initial or final modeling group) SKU having the highest dollar importance according to the POS data received from the sales trend data source 106 (FIG. 1) (block 606). The example feature selector 208 then identifies the qualified features or advertisements having at least one UPC in common with the selected SKU (block 608). If the example feature selector 208 is unable to identify any such features or advertisements (block 610), the selected SKU is marked as unfeatured and is set to be processed after featured SKUs (block 612). The processing of unfeatured SKUs is described in detail below. If the example feature selector 208 is able to identify at least one qualified feature or advertisement having at least one UPC in common with the selected SKU (block 610), the example feature selector 208 then determines which of the identified features or advertisements includes the most UPCs (e.g., by volume as indicated in the feature identifiers) and selects the same as a basis for an initial modeling group (block 614).

In particular, the example SKU grouper 210 creates an initial modeling group by grouping together the SKUs corresponding to products of a similar type (e.g., according to the categorical value(s) associated with the product(s) of the SKU stored in the product characteristic data source 104 of FIG. 1) appearing in the selected feature or advertisement (block 616). In the illustrated example of FIG. 6, the grouping comprises assigning an initial modeling group number to the UPCs corresponding to the products of the grouped SKUs.

The initial modeling groups are then conveyed to the example token test unit 214 of FIG. 2 to be split based on brand aggregation levels (block 618). As described above, the brand level at which the example token test unit 214 splits the initial modeling groups is adjustable (e.g., according to what type or category of product is being analyzed). In the illustrated example, the initial modeling group splitter 212 is set to a default value until otherwise instructed (e.g., by a consumer activity measurement entity implementing the example modeling system 100 described herein).

The example token test unit 214 produces one or more final modeling groups (PPGs) that are homogeneous with respect to price, product type, and promotional scheduling. If, after the token test is performed at block 618, any SKUs having complete data that has not been assigned to a PPG (block 620), control returns to block 606, at which point the unassigned SKU having the next highest dollar importance is selected by the example SKU selector 206. Otherwise, if every SKU having complete information (e.g., as indicated by an attribute assigned to the SKU by the SKU definer 200) has been assigned to a modeling group (block 620), the example SKU grouper 210 proceeds to group unfeatured SKUs (block 622). In particular, the example SKU grouper 210 groups the unfeatured SKUs according to product type, a bottom brand name, and base pack size and size.

The example regrouper 216 then determines whether any modeling groups should be regrouped to avoid redundancies and/or overlapping of the modeling groups. Specifically, the example regrouper 216 identifies instances in which one or more aspects of modeling groups overlap (e.g., via a search of the final modeling groups as generated by the SKU grouper 210 and/or initial modeling group splitter 212) and marks such instances as candidates for regrouping (block 624). If regrouping candidates exist, the example regrouper then regroups or does not regroup the candidate modeling groups according to a set of rules. In the illustrated example, the rules include regrouping according to dollar importance (block 626). In the illustrated example, the regrouper 216 determines that two overlapping modeling groups are to be regrouped if the overlapping modeling group (e.g., the modeling group associated with a product that falls into the range of products of another modeling group with respect to, for example, base size) has a lower dollar importance (e.g., less revenue associated with the SKUs of the modeling group) than the first modeling group. In such instances, the UPCs of the second modeling group are added to the first modeling group and, in some examples, the second modeling group is deleted. In other examples, the second modeling group is completely erased. If the second modeling group has an equal or higher dollar importance compared to the first modeling group, the first and second modeling groups are not regrouped.

FIG. 7 is a block diagram of an example processor system 702 that may be used to implement some or all of the example methods and apparatus described herein. As shown in FIG. 7, the processor system 702 includes a processor 704 that is coupled to an interconnection bus 706. The processor 704 includes a register set or register space 708, which is depicted in FIG. 7 as being entirely on-chip, but which could alternatively be located entirely or partially off-chip and directly coupled to the processor 704 via dedicated electrical connections and/or via the interconnection bus 706. The processor 704 may be any suitable processor, processing unit or microprocessor. Although not shown in FIG. 7, the system 702 may be a multi-processor system and, thus, may include one or more additional processors that are identical or similar to the processor 704 and that are communicatively coupled to the interconnection bus 706.

The processor 704 of FIG. 7 is coupled to a chipset 710, which includes a memory controller 712 and an input/output (I/O) controller 714. As is well known, a chipset typically provides I/O and memory management functions as well as a plurality of general purpose and/or special purpose registers, timers, etc. that are accessible or used by one or more processors coupled to the chipset 710. The memory controller 712 performs functions that enable the processor 704 (or processors if there are multiple processors) to access a system memory 716 and a mass storage memory 718.

The system memory 716 may include any desired type of volatile and/or non-volatile memory such as, for example, static random access memory (SRAM), dynamic random access memory (DRAM), flash memory, read-only memory (ROM), etc. The mass storage memory 718 may include any desired type of mass storage device including hard disk drives, optical drives, tape storage devices, etc.

The I/O controller 714 performs functions that enable the processor 704 to communicate with peripheral input/output (I/O) devices 720 and 722 and a network interface 724 via an I/O bus 726. The I/O devices 720 and 722 may be any desired type of I/O device such as, for example, a keyboard, a video display or monitor, a mouse, etc. The network interface 724 may be, for example, an Ethernet device, an asynchronous transfer mode (ATM) device, an 802.11 device, a DSL modem, a cable modem, a cellular modem, etc. that enables the processor system 702 to communicate with another processor system.

While the memory controller 712 and the I/O controller 714 are depicted in FIG. 7 as separate functional blocks within the chipset 710, the functions performed by these blocks may be integrated within a single semiconductor circuit or may be implemented using two or more separate integrated circuits.

Although the above description refers to the flowcharts as being representative of methods, those methods may be implemented entirely or in part by executing machine readable instructions. Therefore, the flowcharts are representative of methods and machine readable instructions. For example, one or more of the example methods described above may be a computer implemented method. An example computer implemented method can include one or more operations performed via a computer and some operations performed in additional or alternative manners (e.g., manually).

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A computer implemented method to generate a modeling group for use in a trade promotion response model, comprising:
generating products groups, each of which includes one or more product codes corresponding to substantially similar products;
generating advertisement identifiers, each of which corresponds to an advertisement and one or more product codes associated with one or more products in the advertisement;
selecting a first product group from the product groups;
selecting one of the advertisement identifiers corresponding to one or more product codes that are also in the first product group; and
generating a modeling group for a trade promotion response model by grouping together ones of the product groups that include the product codes corresponding to the selected one of the advertisement identifiers.

2. A computer implemented method as defined in claim 1, further comprising splitting the modeling group into one or more final modeling groups according to brand aggregation levels.

3. A computer implemented method as defined in claim 2, wherein splitting the modeling group includes determining a first brand aggregation level at which the product groups of the modeling group become dissimilar with respect to brand name.

4. A computer implemented method as defined in claim 1, further comprising qualifying the products of the advertisement by comparing base prices to advertised prices.

5. A computer implemented method as defined in claim 1, wherein selecting the first product group comprises determining which of the product groups is associated with a highest dollar importance.

6. A computer implemented method as defined in claim 5, wherein the highest dollar importance is determined by referencing point-of-sale data.

7. A computer implemented method as defined in claim 1, wherein selecting the one of the advertisement identifiers further comprises identifying which of the advertisement identifiers corresponding to the one or more product codes that are also in the first product group is a most populated advertisement identifier.

8. A computer implemented method as defined in claim 1, wherein generating the modeling group further comprises determining which of the products featured in the selected one of the advertisement identifiers are of a substantially similar type.

9. A computer implemented method as defined in claim 1, wherein the product codes comprise universal product codes.

10. A computer implemented method as defined in claim 1, wherein generating products groups, each of which includes one or more product codes corresponding to substantially similar products comprises determining whether products are substantially similar by referencing one or more product characteristics of description strings associated with the product codes.

11. A computer implemented method as defined in claim 10, wherein the product characteristics include at least one of a base description, a base size, or a base pack size.

12. (canceled)

13. (canceled)

14. (canceled)

15. (canceled)

16. (canceled)

17. (canceled)

18. (canceled)

19. (canceled)

20. A modeling group generator for use in a trade promotion response model, comprising:
a unit definer to generate products groups, each of which includes one or more product codes corresponding to substantially similar products;
a feature identifier generator to generate advertisement identifiers, each of which corresponds to an advertisement and one or more product codes associated with one or more products in the advertisement;
a unit selector to select a first product group from the product groups;
a feature selector to select one of the advertisement identifiers corresponding to one or more product codes that are also in the first product group; and
a unit grouper to generate a modeling group for a trade promotion response model by grouping together ones of the product groups that include the product codes corresponding to the selected one of the advertisement identifiers.

21. A modeling group generator as defined in claim 20, further comprising a group splitter to split the modeling group into one or more final modeling groups according to brand aggregation levels.

22. A modeling group generator as defined in claim 21, wherein the group splitter is to split the modeling group by determining a first brand aggregation level at which the product groups of the modeling group become dissimilar with respect to brand name.

23. A modeling group generator as defined in claim 20, further comprising a feature qualifier to qualify the products of the advertisement by comparing base prices to advertised prices.

24. A modeling group generator as defined in claim 20, wherein the unit selector is to select the first product group by determining which of the product groups is associated with a highest dollar importance.

25. A modeling group generator as defined in claim 24, wherein the highest dollar importance is determined by referencing point-of-sale data.

26. A modeling group generator as defined in claim 20, wherein the feature selector is to select the one of the advertisement identifiers by identifying which of the advertisement identifiers corresponding to the one or more product codes that are also in the first product group is a most populated identifier.

27. A modeling group generator as defined in claim 20, wherein the unit grouper is to generate the modeling group by determining which of the products featured in the selected one of the advertisement identifiers are of a substantially similar type.

28. A trade promotion response modeling system, comprising:
a promotion detection system to collect information related to a plurality of advertisements;
a product characteristic source including product characteristics associated with a plurality of products of a marketplace;
a sales trend data source including financial information related to the plurality of products; and
a modeling group generator comprising
a plurality of product groups, each of which includes one or more product codes corresponding to substantially similar products; and
a plurality of advertisement identifiers, each of which corresponds to an advertisement and one or more product codes associated with one or more products in the advertisement, wherein the modeling group generator is configured to select a first one of the advertisements based on a first code of a first one of the product groups, and wherein the modeling group generator is configured to generate a modeling group for a trade promotion response model by grouping together ones of the product groups that include the product codes corresponding to the selected one of the advertisement identifiers.
